(19) United States
(12) Patent Application Publication
(10) Pub. No.: US 2020/0413114 A1
(43) Pub. Date: Dec. 31, 2020

(54) HUMAN EVALUATION AND APPROVAL OF VIDEO APPROPRIATE FOR VIEWING BY CHILDREN

(71) Applicant: David Hernandez, San Marcos, CA (US)

(72) Inventor: David Hernandez, San Marcos, CA (US)

(21) Appl. No.: 16/452,411

(22) Filed: Jun. 25, 2019

(51) Int. Cl. H04N 21/234; H04N 21/2668; G06F 16/75

(52) U.S. Cl. CPC H04N 21/23418; G06F 16/75; H04N 21/2668

(57) ABSTRACT

A method for evaluating video to ensure appropriateness for viewing by children. A video submission computer is utilized to upload unevaluated video to a video evaluation and display website installed on a server computer. The unevaluated video is then downloaded from the website to a video evaluation computer where a human being views the video for the purpose of evaluating the video for appropriateness for children. The human being will then evaluate the video to either approve the video or reject the video. If the human being cannot decide whether to approve or reject the video, in a preferred embodiment the human being may refer the decision to a supervisor or a secondary review team. If the human being approves the video, the video is transferred to an approved video database where it may be downloaded by a child for viewing. If the human being rejects the video, the video is transferred to a rejected video database.

The present invention relates to online video viewing, and in particular, to methods for screening and approving video for online viewing.

### BACKGROUND OF THE INVENTION

The viewing of video online is well known. One of the most popular websites for online video viewing is at www.youtube.com. YOUTUBE® is a federally registered trademark that commonly refers to “ . . . a website featuring user-generated content, namely, electronic media, multimedia content, videos, movies, pictures, images, text, photos, audio content, and related information via the Internet and other communications networks on a wide variety of topics and subjects . . . ”. Despite its popularity, YOUTUBE® has had significant problems in many areas. One challenging area for YOUTUBE® is the challenge associated with verifying that videos accessible on its website are appropriate for children. In many cases, videos easily found on YOUTUBE® are inappropriate for viewing by children. Some of these videos may contain nudity, violence, profanity, sexual content, or suggestive behavior. In an effort to provide a safe forum for children, YOUTUBE advertises that users may download an app entitled YOUTUBE KIDS. YOUTUBE KIDS proports to only have videos that are appropriate for children 12 and under. However, it is clear that there have been videos on YOUTUBE KIDS that are disturbing and inappropriate for children. YOUTUBE KIDS utilizes a computer algorithm to screen videos. Unfortunately, despite sophisticated computer programming, the computer screening has failed and unsafe, inappropriate videos continue to be displayed on YOUTUBE, YOUTUBE KIDS and other prior art websites for video viewing.

What is needed is an improved method for providing a website where all videos displayed are appropriate for viewing by children.

### SUMMARY OF THE INVENTION

The present invention provides a method for evaluating video to ensure appropriateness for viewing by children. A video submission computer is utilized to upload unevaluated video to a video evaluation and display website installed on a server computer. The unevaluated video is then downloaded from the website to a video evaluation computer where a human being views the video for the purpose of evaluating the video for appropriateness for children. The human being will then evaluate the video to either approve the video or reject the video. If the human being cannot decide whether to approve or reject the video, in a preferred embodiment the human being may refer the decision to a supervisor or a secondary review team. If the human being approves the video, the video is transferred to an approved video database where it may be downloaded by a child for viewing. If the human being rejects the video, the video is transferred to a rejected video database.

### BRIEF DESCRIPTION OF THE DRAWINGS

FIG. 1 shows connectivity of a preferred embodiment of the present invention.

FIG. 2 shows a preferred collection of video evaluation computers.

FIG. 3 shows a flowchart depicting the operation of a preferred embodiment of the present invention.

### DETAILED DESCRIPTION OF THE PREFERRED EMBODIMENTS

The present invention provides a website for video viewing where videos are evaluated by human beings to ensure appropriateness for children. The present invention recognizes that it is only with a human being personally viewing a video that the video may be properly classified as having appropriate content for children. The evaluators watch and listen to each video and look to ensure that each video has no nudity, violence, profanity, sexual content, or suggestive behavior. The evaluators also check to verify that each video concerns only subject matter that is appropriate for children 12 and under. If an evaluator is unsure as to whether a video is appropriate for children, the evaluator may refer the video to be reviewed by a supervisor or a secondary review team. If the video is approved it will then be accessible for download and viewing by children. By utilizing the preferred methods described herein, applicant has been able to successfully approve 350,000 hours of video for viewing by children.

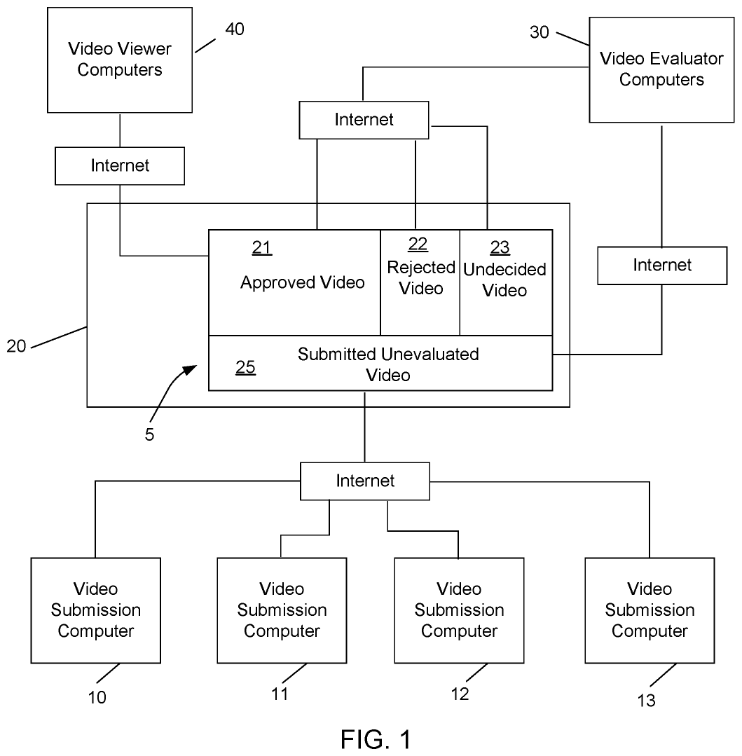

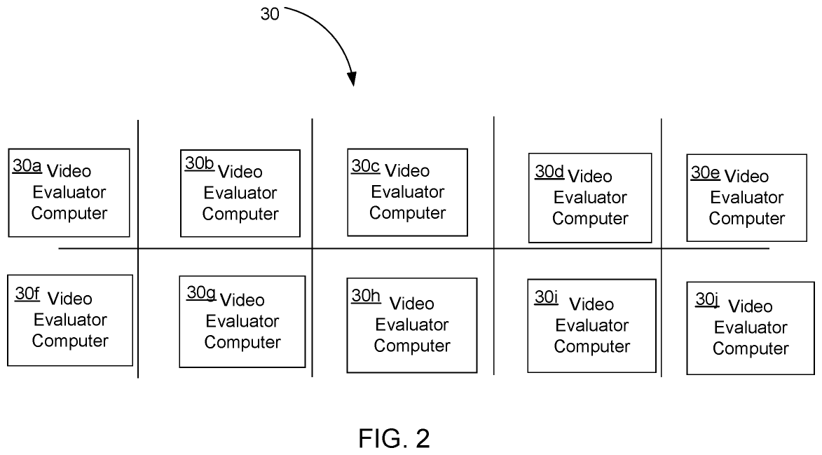

FIGS. 1-2 show a preferred embodiment of the present invention. Multiple video submission computers 10-13 are connected to server computer 20 via the Internet. Video Evaluation and Display website 5 has been loaded onto server computer 20. Video submission computers 10-13 are programmed and connected so as to be able to upload videos for evaluation to submitted unevaluated video database 25. Video evaluator computers 30 are also connected to server computer 20 and are able to access submitted unevaluated videos stored at unevaluated video database 25 for evaluation. Video evaluation computers 30 also are programmed and connected so as to be able to transfer evaluated videos to either approved video database 21, rejected video database 22 or undecided video database 23. Video viewer computers 40 are connected to server computer 20 via the Internet and include programming so as to be able to download videos from approved video database 21.

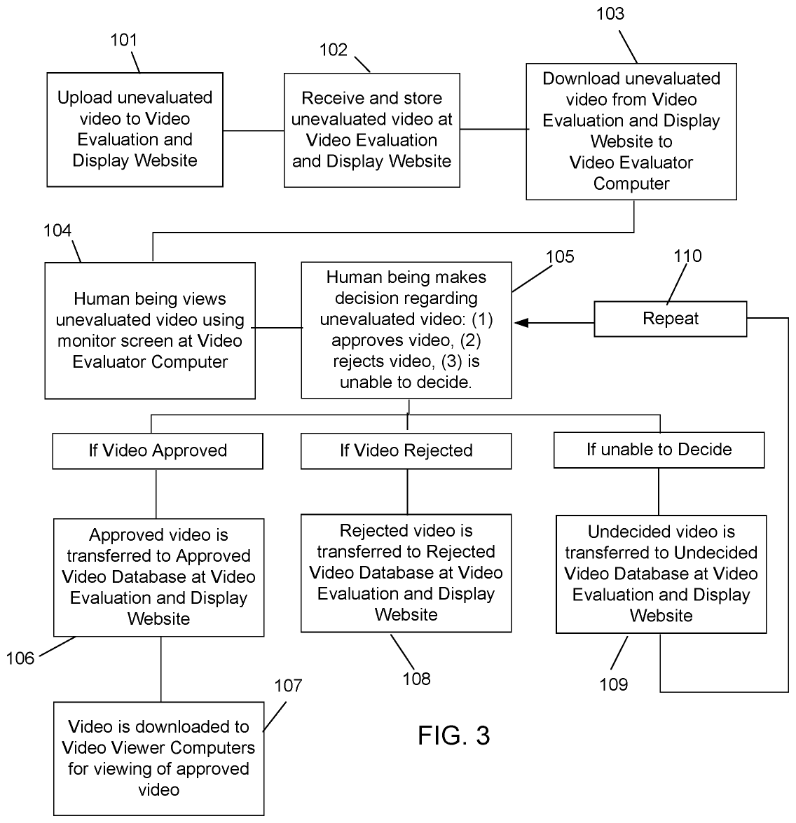

FIG. 3 shows a flowchart describing the operation of a preferred embodiment of the present invention. In step 101, users operating video submission computers 10-13 will each upload a video to video evaluation and display website 5 for the purpose of evaluation. In step 102, the unevaluated video is received and stored at submitted unevaluated video database 25 (FIG. 1). In step 103, unevaluated video is downloaded from database 25 of the video evaluation and display website to video evaluator computers 30 (FIG. 1) for the purpose of evaluation. In step 104, a human being views unevaluated video using a monitor screen at one of the video evaluator computers 30. In step 105, the human being makes a decision regarding the unevaluated video. The human being can either: 1) approve the video, 2) reject the video, or 3) remain undecided. If the video is approved (as shown in step 106), the video will be transferred and saved onto approved video database 21 of website 5. In step 107, the approved video is then downloaded to video viewer computers 40 for viewing. If the human being rejects the video (as shown in step 108), the video will be transferred and saved onto rejected video database 22 of website 5. If the human being cannot decide whether to approve the video or reject the video (as shown in step 109), the video will be transferred and saved onto undecided video database 23 of website 5. The human being will then be able to continue to access the undecided video via undecided video database 23 to repeat the evaluation, as shown in step 110. In a preferred embodiment, a supervisor of the human being will conduct the evaluation and make a decision, as shown in step 105.

FIG. 2 depicts a preferred arrangement of video evaluator computers 30. In FIG. 2, ten video evaluator computers 30a-30j are arranged in an office space as shown. At each computer is a human being computer operator. As explained above, each human being evaluator observes an unevaluated video in its entirety. The human being will make a decision as to whether the video is approved or rejected. The human being may also be unable make a decision outright. In this case the human being can try again later after another viewing. Or, the human being may decide to get help from a supervisor or secondary review team.

In the preferred embodiment shown in FIG. 2, each human being is positioned in front of a computer so that she can easily view the computer monitor screen without distraction. In a preferred embodiment each human being is assigned a cubicle where she may view videos throughout the day. Preferably the human being is monitored just to verify that she is focusing on the videos present to her throughout the day.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

1. A method for evaluating video to ensure appropriateness for children, said method comprising the steps of:
A. utilizing a video submission computer to upload unevaluated video to a video evaluation and display website installed on a server computer,
B. receiving said unevaluated video at said video evaluation and display website,
C. downloading said unevaluated video from said video evaluation and display website to a video evaluation computer,
D. utilizing a human being to view said unevaluated video for the purpose of evaluating said video to ensure appropriateness for children,
E. utilizing a human being to evaluate said unevaluated video to determine if said unevaluated video is:
i. approved video,
ii. rejected video, and
iii. undecided video,
F. transferring approved video to an approved video database if said unevaluated video is determined to be approved after said evaluation,
G. downloading said approved video to a video viewer computer for viewing by children,
H. transferring rejected video to a rejected video database if said unevaluated video is determined to be rejected after said evaluation,
I. transferring undecided video to an undecided video database if said unevaluated video is determined to be undecided after said evaluation, and
J. repeating evaluation of said undecided video to either approve or reject said undecided video.

2. The method as in claim 1, wherein said video evaluation computer is a plurality of video evaluation computers, each video evaluation computer being monitored by a human being, wherein said plurality of video evaluation computers and said plurality of human beings are located in an office space with a supervisor, wherein each human being is monitored by said supervisor to verify that each human being is focusing on the video presented to the human being on said video evaluation computer.

3. The method as in claim 1, further comprising the step of utilizing a supervisor to monitor said human being to ensure said human being is focused on said evaluation of said unevaluated video.

4. The method as in claim 1, wherein said repeating evaluation of said undecided video is conducted by a supervisor or a secondary review team.

5. A method for evaluating video to ensure appropriateness for children, said method comprising the steps of:
A. utilizing a video submission computer to upload unevaluated video to a video evaluation and display website installed on a server computer,
B. receiving said unevaluated video at said video evaluation and display website,
C. downloading said unevaluated video from said video evaluation and display website to a plurality of video evaluation computers, each video evaluation computer being monitored by a human being, wherein said plurality of video evaluation computers are located in an office space so that each human being is monitored by a supervisor to verify that the human being is focusing on the videos presented to the human being on said video evaluation computer,
D. utilizing a human being to view said unevaluated video for the purpose of evaluating said video to ensure appropriateness for children,
E. utilizing a human being to evaluate said unevaluated video to determine if said unevaluated video is:
i. approved video,
ii. rejected video, and
iii. undecided video,
F. transferring approved video to an approved video database if said unevaluated video is determined to be approved after said evaluation,
G. downloading said approved video to a video viewer computer for viewing by children,
H. transferring rejected video to a rejected video database if said unevaluated video is determined to be rejected after said evaluation,
I. transferring undecided video to an undecided video database if said unevaluated video is determined to be undecided after said evaluation, and
J. repeating evaluation of said undecided video to either approve or reject said undecided video, wherein said repeating evaluation of said undecided video is conducted by a supervisor or a secondary review team
